(19) United States
(12) Patent Application Publication
(10) Pub. No.: US 2006/0183451 A1
(43) Pub. Date: Aug. 17, 2006

(54) Method and system for continuously compensating for phase variations introduced into a communication signal by automatic gain control adjustments

(75) Inventors: Alpaslan Demir, Commack, NY (US); Leonid Kazakevich, Plainview, NY (US); Tanbir Haque, Long Island City, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/736,432

(22) Filed: Dec. 15, 2003

Related U.S. Application Data
(60) Provisional application No. 60/476,471, filed on Jun. 6, 2003.

(51) Int. Cl. H04B 1/06; H04B 7/00

(52) U.S. Cl. 455/232.1

(57) ABSTRACT

A communication system including an automatic control (AGC) circuit, a receiver, an analog to digital converter (ADC) and an insertion phase variation compensation module. The AGC circuit receives and amplifies communication signals. The gain of the AGC circuit is continuously adjusted. The AGC circuit outputs an amplified signal to the receiver which, in turn, outputs an analog complex signal to the ADC. The ADC outputs a digital complex signal to an insertion phase variation compensation module which counteracts the effects of phase offsets introduced into the communication signal due to the continuous gain adjustments associated with the AGC circuit.

### CROSS REFERENCE TO RELATED APPLICATION(S)

This application claims priority from U.S. provisional application No. 60/476,471, filed Jun. 6, 2003, which is incorporated by reference as if fully set forth.

### FIELD OF THE INVENTION

The present invention generally relates to wireless communication systems. More particularly, the present invention relates to digital signal processing (DSP) techniques used to compensate for phase variations associated with automatic gain control (AGC) adjustments.

### BACKGROUND

In a conventional phase-sensitive communication system, a receiver uses automatic gain control (AGC) to automatically adjust gain as a function of the amplitude of a radio frequency (RF) and/or intermediate frequency (IF) communication signal. A real valued gain factor generated by the AGC is applied to the communication signal. In the analog domain, the amplitude of the communication signal is maintained within a predefined signal amplitude range and is then converted to a digital signal by an analog to digital converter (ADC), which also limits the signal amplitude range. The objective of the AGC is to maintain a constant power level at the input to the ADC.

When the AGC is adjusted, a phase offset is introduced into the communication signal which degrades the performance of the phase-sensitive communication system. A method and system is desired for canceling the phase offset of the communication signal caused by adjusting the AGC.

### SUMMARY

The present invention is incorporated into a communication system which includes an AGC circuit, a receiver, an analog to digital converter (ADC) and an insertion phase variation compensation module. The AGC circuit receives and amplifies communication signals. The gain of the AGC circuit is continuously adjusted. The AGC circuit outputs an amplified communication signal to the receiver which, in turn, outputs an analog complex signal to the ADC. The ADC outputs a digital complex signal to the insertion phase variation compensation module which counteracts the effects of phase offsets introduced into the communication signal due to the continuous gain adjustments associated with the AGC circuit. The analog and digital complex signals include in-phase (I) and quadrature (Q) signal components.

The gain of the AGC circuit is continuously adjusted in response to a gain control signal. Estimates of the phase offsets are provided to the insertion phase variation compensation module as a function of the gain control signal.

The insertion phase variation compensation module may receive the digital I and Q signal components from the ADC and output altered I and Q signal components having different phase characteristics than the digital I and Q signal components. The communication system may further include a modem which receives the altered I and Q signal components. The modem may include a processor which generates the gain control signal. The processor may calculate how much power is input to the ADC.

The communication system may further include a look up table (LUT) in communication with the processor and the insertion phase variation compensation module. The LUT may receive the gain control signal from the processor and provide estimates of the phase offsets to the insertion phase variation compensation module as a function of the gain control signal. The provided estimates may include a Sin function and a Cos function of a phase offset, x. The insertion phase variation compensation module may have a real, Re, input associated with a digital I signal component and an imaginary, Im, input associated with a Q signal component and, based on the estimates provided by the LUT, the insertion phase variation compensation module may output an I signal component having a phase that is adjusted in accordance with the function (Cos(x)×Re)−(Sin(x)×Im) and a Q signal component having a phase that is adjusted in accordance with the function (Sin(x)×Re)+(Cos(x)×Im).

### BRIEF DESCRIPTION OF THE DRAWINGS

A more detailed understanding of the invention may be had from the following description of a preferred example, given by way of example and to be understood in conjunction with the accompanying drawing wherein:

FIG. 1 is a block diagram of a communication system including an insertion phase variation compensation module that cancels out phase offsets introduced into a communication signal by an AGC circuit in accordance with the present invention;

FIG. 2 is an exemplary configuration of the insertion phase variation compensation module of FIG. 1; and

FIG. 3 is a flow chart of a process including steps implemented to continuously counteract the effects of phase offsets introduced into a communication signal by the AGC circuit of FIG. 1.

### DETAILED DESCRIPTION OF THE PREFERRED EMBODIMENTS

The present invention provides a method and system that cancels out the phase difference introduced into an RF or IF communication signal, (i.e., data stream), by performing AGC adjustments.

Preferably, the method and system disclosed herein is incorporated into a wireless transmit/receive unit (WTRU). Hereafter, a WTRU includes but is not limited to a user equipment, mobile station, fixed or mobile subscriber unit, pager, or any other type of device capable of operating in a wireless environment. The features of the present invention may be incorporated into an integrated circuit (IC) or be configured in a circuit comprising a multitude of interconnecting components.

The present invention is applicable to communication systems using time division duplex (TDD), frequency division duplex (FDD), code division multiple access (CDMA), CDMA 2000, time division synchronous CDMA (TDSCDMA), orthogonal frequency division multiplexing (OFDM) or the like.

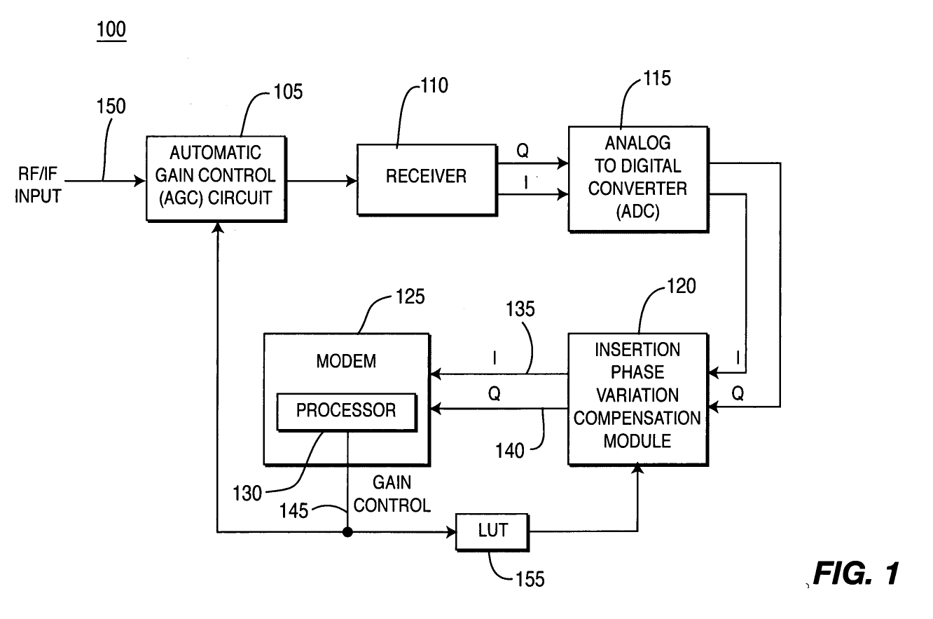

FIG. 1 is a block diagram of a communication system 100 operating in accordance with the present invention. Communication system 100 includes an AGC circuit 105, a receiver 110, an analog to digital converter (ADC) 115, an insertion phase variation compensation module 120 and a modem 125. The AGC circuit 105 and the ADC 115 may be incorporated into receiver 110. The AGC circuit 105 may include a single gain stage or multiple gain stages. Furthermore, the insertion phase variation compensation module 120 may be incorporated into the modem 125.

The modem 125 includes a processor 130 which calculates how much power is input to the ADC 115. The modem 125 receives complex I and Q signal components 135, 140, from the insertion phase variation compensation module 120, and, via processor 130, outputs a gain control signal 145 to the AGC circuit 105. The gain control signal 145 includes a gain factor used by the AGC circuit 105 to set the amplitude of an RF and/or IF communication signal 150. The gain control signal 145 is also output from the processor 130 to a look up table (LUT) 155 which uses the gain control signal 145 to provide the insertion phase variation compensation module 120 with an estimate of the phase offset that is introduced into the communication signal 150. Alternatively, a predefined polynomial or any other method may be used in lieu of the LUT 155 to provide the estimate of the phase offset.

Each time the gain level of the gain stage(s) of the AGC circuit 105 is changed, an associated phase offset, i.e., phase rotation, may be introduced into the communication signal 150. Thus, an estimate of the phase offset (x) as a function of the gain provided by the AGC circuit 105 may be determined on a continuous basis by accessing the LUT 155, a predefined polynomial, or any other method that can map a full range of AGC values associated with the AGC circuit 105 to a phase offset estimate.

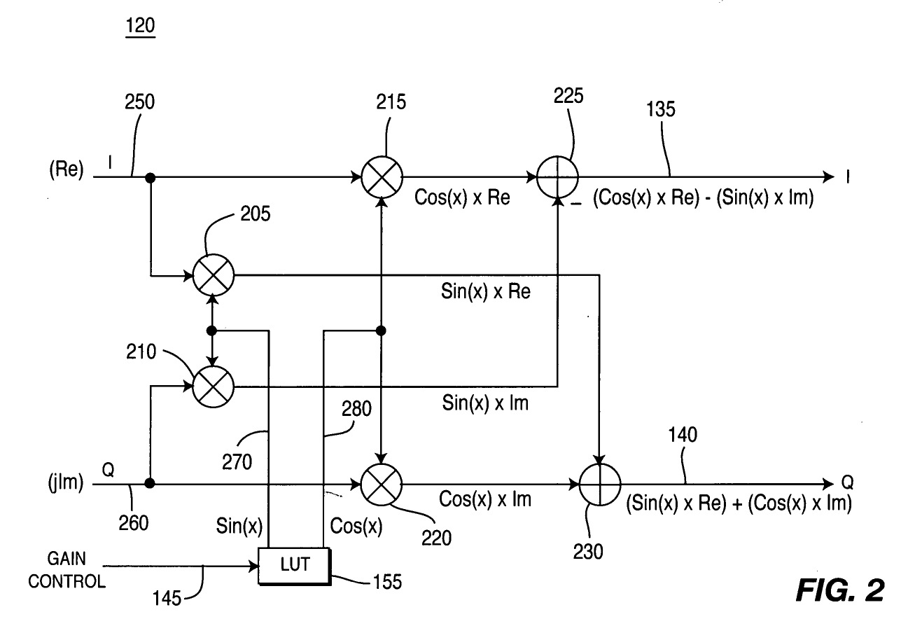

FIG. 2 shows an exemplary configuration of the insertion phase variation compensation module 120 which rotates the phase characteristics of the I and Q signal components of a digital complex signal output from the ADC 115 based on the gain control signal 145, so as to counteract the effects of phase offsets introduced into a communication signal 150 by the AGC circuit 105. Thus, the modem 125 is not affected by the phase offsets and the performance of the communication system 100 is not degraded. Different gain levels will introduce different gain offsets into the communication signal 150.

As shown in FIG. 2, the insertion phase variation compensation module 120 includes multipliers 205, 210, 215, 220 and adders 225 and 230. The insertion phase variation compensation module 120 receives a real (Re) I signal component 250 and an imaginary (Im) Q signal component 260 from the ADC 115 and rotates the phase of the signal components Re and jIm by x degrees (e^{jx}) as described by Equation 1 below:
(Re+jIm)×e^{jx}=(Re+jIm)×(Cos(x)+jSin(x)) Equation 1

The outcome of the real output, Re, is described by Equation 2 below:
\hat{R}e=(Cos(x)×Re)+(j²×Sin(x)×Im)=(Cos(x)×Re)−(Sin(x)×Im) Equation 2
Note that if x is close to zero, then Cos(x)=1.0 and Sin(x)=x, as described by Equation 3 below:
\hat{R}e=Re−Im×x Equation 3

The output of the imaginary output, Î m, is described by Equation 4 below:
Î m=(Sin(x)×Re)+(Cos(x)×Im) Equation 4
Note that if x is close to zero, then Cos(x)=1.0 and Sin(x)=x, as described by Equation 5 below:
Î m=Im+Re×x Equation 5

Thus, as depicted by Equation 2, the real signal component 250 is multiplied by a Cos(x) function 280 specified by the LUT 155 via the multiplier 215 and the imaginary signal component 260 is multiplied by a Sin (x) function 270 also specified by the LUT 155 via the multiplier 210, whereby the output of the multiplier 210 is subtracted from the output of the multiplier 215 by the adder 225. Furthermore, as depicted by Equation 4, the real signal component 250 is multiplied by a Sin(x) function 270 specified by the LUT 155 via the multiplier 205 and the imaginary signal component 260 is multiplied by a Cos(x) function 280 also specified by the LUT 155 via the multiplier 220, whereby the output of the multiplier 220 is added to the output of the multiplier 205 by the adder 230.

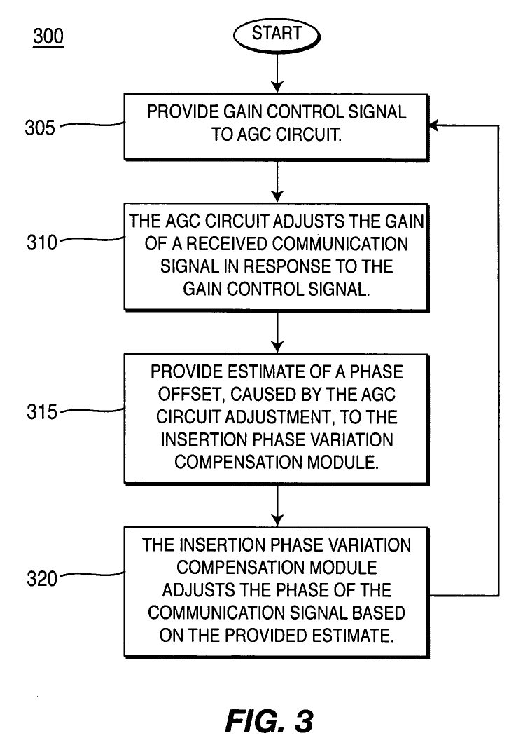

FIG. 3 is a flow chart of a process 300 including steps implemented to continuously counteract the effects of phase offsets introduced into a communication signal 150 received by the AGC circuit 105. In step 305, the gain control signal 145 is provided to the AGC circuit 105. In step 310, the AGC circuit 105 adjusts the gain of a communication signal 150 in response to the gain control signal 145, the adjustment causing a phase offset to be introduced into the communication signal 150. In step 315, an estimate of the phase offset is provided to the insertion phase variation compensation module 120 as a function of the gain control signal 145. In step 320, the insertion phase variation compensation module 120 adjusts the phase of the communication signal 150 based on the provided estimate. The process 300 repeats on a continuous basis.

While this invention has been particularly shown and described with reference to preferred embodiments, it will be understood by those skilled in the art that various changes in form and details may be made therein without departing from the scope of the invention described hereinabove.

What is claimed is:

1. A communication system comprising:
(a) an automatic gain control (AGC) circuit which receives and adjusts the gain of a communication signal, the AGC being controlled by a gain control signal; and
(b) an insertion phase variation compensation module which continuously counteracts the effects of phase offsets introduced into the communication signal by the AGC circuit, based on the gain control signal.

2. The communication system of claim 1 further comprising:
(c) a receiver which receives the communication signal from the AGC circuit and outputs analog in-phase (I) and quadrature (Q) signal components; and
(d) an analog to digital converter (ADC) which receives and converts the analog I and Q signal components to digital I and Q signal components.

3. The communication system of claim 2 wherein the insertion phase variation compensation module receives the digital I and Q signal components from the ADC and outputs altered I and Q signal components having different phase characteristics than the digital I and Q components, the communication system further comprising:
(e) a modem which receives the altered I and Q signal components, the modem including a processor which generates the gain control signal.

4. The communication system of claim 3 wherein the processor calculates how much power is input to the ADC.

5. The communication system of claim 2 wherein the insertion phase variation compensation module receives the digital I and Q components from the ADC and alters the phase characteristics of the digital I and Q components as a function of the gain control signal.

6. The communication system of claim 1 further comprising:
(c) a processor which generates the gain control signal; and
(d) a look up table (LUT) in communication with the processor and the insertion phase variation compensation module, wherein the LUT receives the gain control signal from the processor and provides estimates of the phase offsets to the insertion phase variation compensation module as a function of the gain control signal.

7. The communication system of claim 6 wherein the provided estimates include a Sin function and a Cos function of a phase offset, x.

8. The communication system of claim 7 wherein the insertion phase variation compensation module has a real, Re, input associated with a digital in-phase (I) signal component and an imaginary, Im, input associated with a quadrature (Q) signal component and, based on the estimates provided by the LUT, the insertion phase variation compensation module outputs an I signal component having a phase that is adjusted in accordance with the following function: (Cos(x)×Re)−(Sin(x)×Im).

9. The communication system of claim 7 wherein the insertion phase variation compensation module has a real input, Re, associated with a digital in-phase (I) signal component and an imaginary input, Im, associated with a quadrature (Q) signal component and, based on the estimates provided by the LUT, the insertion phase variation compensation module outputs a Q signal component having a phase that is adjusted in accordance with the following function: (Sin(x)×Re)+(Cos(x)×Im).

10. A wireless transmit/receive unit (WTRU) comprising:
(a) an automatic gain control (AGC) circuit which receives and adjusts the gain of a communication signal, the AGC being controlled by a gain control signal; and
(b) an insertion phase variation compensation module which continuously counteracts the effects of phase offsets introduced into the communication signal by the AGC circuit, based on the gain control signal.

11. The WTRU of claim 10 further comprising:
(c) a receiver which receives the communication signal from the AGC circuit and outputs analog in-phase (I) and quadrature (Q) signal components; and
(d) an analog to digital converter (ADC) which receives and converts the analog I and Q signal components to digital I and Q signal components.

12. The WTRU of claim 11 wherein the insertion phase variation compensation module receives the digital I and Q signal components from the ADC and outputs altered I and Q signal components having different phase characteristics than the digital I and Q components, the WTRU further comprising:
(e) a modem which receives the altered I and Q signal components, the modem including a processor which generates the gain control signal.

13. The WTRU of claim 12 wherein the processor calculates how much power is input to the ADC.

14. The WTRU of claim 11 wherein the insertion phase variation compensation module receives the digital I and Q components from the ADC and alters the phase characteristics of the digital I and Q components as a function of the gain control signal.

15. The WTRU of claim 10 further comprising:
(c) a processor which generates the gain control signal; and
(d) a look up table (LUT) in communication with the processor and the insertion phase variation compensation module, wherein the LUT receives the gain control signal from the processor and provides estimates of the phase offsets to the insertion phase variation compensation module as a function of the gain control signal.

16. The WTRU of claim 15 wherein the provided estimates include a Sin function and a Cos function of a phase offset, x.

17. The WTRU of claim 16 wherein the insertion phase variation compensation module has a real, Re, input associated with a digital in-phase (I) signal component and an imaginary, Im, input associated with a quadrature (Q) signal component and, based on the estimates provided by the LUT, the insertion phase variation compensation module outputs an I signal component having a phase that is adjusted in accordance with the following function: (Cos(x)×Re)−(Sin(x)×Im).

18. The WTRU of claim 16 wherein the insertion phase variation compensation module has a real input, Re, associated with a digital in-phase (I) signal component and an imaginary input, Im, associated with a quadrature (Q) signal component and, based on the estimates provided by the LUT, the insertion phase variation compensation module outputs a Q signal component having a phase that is adjusted in accordance with the following function: (Sin(x)×Re)+(Cos(x)×Im).

19. An integrated circuit (IC) comprising:
(a) an automatic gain control (AGC) circuit which receives and adjusts the gain of a communication signal, the AGC being controlled by a gain control signal; and
(b) an insertion phase variation compensation module which continuously counteracts the effects of phase offsets introduced into the communication signal by the AGC circuit, based on the gain control signal.

20. The IC of claim 19 further comprising:
(c) a receiver which receives the communication signal from the AGC circuit and outputs analog in-phase (I) and quadrature (Q) signal components; and
(d) an analog to digital converter (ADC) which receives and converts the analog I and Q signal components to digital I and Q signal components.

21. The IC of claim 20 wherein the insertion phase variation compensation module receives the digital I and Q signal components from the ADC and outputs altered I and Q signal components having different phase characteristics than the digital I and Q components, the WTRU further comprising:
(e) a modem which receives the altered I and Q signal components, the modem including a processor which generates the gain control signal.

22. The IC of claim 21 wherein the processor calculates how much power is input to the ADC.

23. The IC of claim 20 wherein the insertion phase variation compensation module receives the digital I and Q components from the ADC and alters the phase characteristics of the digital I and Q components as a function of the gain control signal.

24. The IC of claim 19 further comprising:
(c) a processor which generates the gain control signal; and
(d) a look up table (LUT) in communication with the processor and the insertion phase variation compensation module, wherein the LUT receives the gain control signal from the processor and provides estimates of the phase offsets to the insertion phase variation compensation module as a function of the gain control signal.

25. The IC of claim 24 wherein the provided estimates include a Sin function and a Cos function of a phase offset, x.

26. The IC of claim 25 wherein the insertion phase variation compensation module has a real, Re, input associated with a digital in-phase (I) signal component and an imaginary, Im, input associated with a quadrature (Q) signal component and, based on the estimates provided by the LUT, the insertion phase variation compensation module outputs an I signal component having a phase that is adjusted in accordance with the following function: (Cos(x)×Re)−(Sin(x)×Im).

27. The IC of claim 25 wherein the insertion phase variation compensation module has a real input, Re, associated with a digital in-phase (I) signal component and an imaginary input, Im, associated with a quadrature (Q) signal component and, based on the estimates provided by the LUT, the insertion phase variation compensation module outputs a Q signal component having a phase that is adjusted in accordance with the following function: (Sin(x)×Re)+(Cos(x)×Im).

28. In a communication system including an automatic gain control (AGC) circuit and an insertion phase variation compensation module, a method of continuously counteracting the effects of phase offsets introduced into a communication signal by the AGC circuit, the method comprising:
(a) providing a gain control signal to the AGC circuit;
(b) the AGC circuit receiving and adjusting the gain of a communication signal in response to the gain control signal, the adjustment causing a phase offset to be introduced into the communication signal;
(c) providing an estimate of the phase offset to the insertion phase variation compensation module as a function of the gain control signal;
(d) the insertion phase variation compensation module adjusting the phase of the communication signal based on the provided estimate; and
(e) repeating steps (a)-(d).

29. The method of claim 28 wherein the provided estimate includes a Sin function and a Cos function of a phase offset, x.

30. The method of claim 29 wherein the insertion phase variation compensation module has a real, Re, input associated with a digital in-phase (I) signal component and an imaginary, Im, input associated with a quadrature (Q) signal component and, based on the estimate provided by the LUT, the insertion phase variation compensation module outputs an I signal component having a phase that is adjusted in accordance with the following function: (Cos(x)×Re)−(Sin(x)×Im).

31. The method of claim 29 wherein the insertion phase variation compensation module has a real input, Re, associated with a digital in-phase (I) signal component and an imaginary input, Im, associated with a quadrature (Q) signal component and, based on the estimate provided by the LUT, the insertion phase variation compensation module outputs a Q signal component having a phase that is adjusted in accordance with the following function: (Sin(x)×Re)+(Cos(x)×Im).
